(19) United States
(12) Patent Application Publication
(10) Pub. No.: US 2025/0292196 A1
(43) Pub. Date: Sep. 18, 2025

(54) CLIENT-SIDE TOOL FOR GEOSPATIAL DATA VISUALIZATION AND ANALYSIS

(71) Applicant: Maps and Data LLC, Hopkins, MN (US)

(72) Inventor: Carston Hernke, Berlin (DE)

(21) Appl. No.: 19/080,469

(22) Filed: Mar. 14, 2025

Related U.S. Application Data
(60) Provisional application No. 63/566,150, filed on Mar. 15, 2024.

(51) Int. Cl. G06Q 10/0834; G06F 3/0484; G06F 16/909; G06Q 10/04

(52) U.S. Cl. CPC G06Q 10/08345; G06F 3/0484; G06F 16/909; G06Q 10/04; G06F 2203/04806

(57) ABSTRACT

A system and method for client-side geospatial data analysis are disclosed. An application bundle, including an embedded database, is sent to a client device, which then locally loads raw geospatial data files. Each coordinate point is associated with a grid index, and user queries—such as polygon-based filters, zoom operations, or attribute-based searches—are executed on the client device in near real time. This design removes the need for continuous server requests, thereby reducing latency and enabling immediate visualization of changes to map views or filters. The approach supports rapid interactions with large datasets, as filtering and aggregation tasks remain under the client's control. Furthermore, the embedded database can perform optimization or allocation routines (for example, delivery assignments) locally, instantly displaying results to the user. By eliminating heavy reliance on external servers, this invention offers a responsive, cost-effective platform for comprehensive geospatial data exploration and decision-making.

### CROSS-REFERENCE TO RELATED APPLICATIONS

This application claims the benefit of U.S. Provisional Application No. 63/566,150, filed on Mar. 15, 2024, the contents of which are hereby incorporated herein by reference.

### FIELD

The present application relates generally to computer-implemented systems and methods and, more particularly, to client-side techniques for real-time geospatial data visualization and analysis. In one aspect, the invention pertains to a client-side tool that efficiently processes geographic information to provide immediate feedback, thereby reducing the latency associated with traditional client-server architectures to enhance user interactivity and responsiveness.

### BACKGROUND

Geographic Information Systems (GIS) are computer systems that store, process, and display data related to the earth's surface. GIS tools are used in a variety of fields including, but not limited to, natural resource management, land planning, emergency management, shipping and logistics, and military and defense. Business Intelligence (BI) tools are a different type of computer system that are designed to store, analyze, and display information related to the performance of an organization.

Over time there has been a large increase in the amount of information that is collected by the public and private sector. GIS and BI tools have been crucial to processing this large amount of information so that decisions can be made based on it. This trend has also led to many GIS and BI tools adopting a ‘client-server’ architecture. In a ‘client-server’ architecture, the user interacts with a client, such as a computer or mobile phone. These interactions may be to request to see a new data layer, to see data aggregated in a certain way, or to filter data for a certain attribute. These interactions then result in a query to be sent to a remote server. The remote server receives these requests and uses a database to efficiently fetch the required data. This data is then sent to the client, which visualizes the data for the user.

However, the separation of data processing and visualization introduces latency, as there is an upper limit to the speed at which data can be transferred from one location to another. This latency manifests itself as a delayed response to user input. This delay can be frustrating to the user of the system, who must wait many seconds to minutes to see the results of their interaction within the GIS or BI systems. This makes these systems unsuitable for presenting the user with real-time feedback. This limits the usefulness of these applications.

The client-server architecture also necessitates maintaining a separate centralized server which can respond to user requests. If the number of users of the application grows, then the processing power of the server must grow as well. This introduces significant costs as the number of users increases.

### SUMMARY

Response times can be significantly reduced if data processing is moved from the server to the client itself. The subject matter described herein is a client-side tool for geospatial data visualization and analysis that performs computations efficiently and operates on the client side, providing real-time feedback to the user. This is accomplished by loading an application bundle that includes an embedded database from a remote source when the application starts, which is then executed by the client. Once the application is executing on the client device, the application fetches one or more data files that includes the data the user desires to analyze. After the application is loaded and data is fetched, subsequent interactions and analysis of the data are computed locally on the client side by the embedded database, resulting in very low latency (e.g., below 80 ms).

This real-time feedback enables the user to repeatedly request varying views, filters, and aggregations of the data, because results from any given query can be computed and observed quickly. Thus, a user can analyze the data using an initial approach, immediately observe results, and refine that analysis based on newly obtained insights. This greatly improves the user's experience and productivity when working with geospatial data.

### BRIEF DESCRIPTION OF THE DRAWINGS

FIG. 1 is a diagram illustrating one example of a process implemented to use the client-side tool.

FIG. 2 is an example of an output from the application, illustrating an irregular polygon that a user has drawn to define a particular geographic area.

FIG. 3 details the data update cycle, illustrating how the query generation module, database coordinator, embedded database, and visualization module cooperate on the client side.

FIG. 4 is a diagram illustrating another process (e.g., a linear programming or optimization routine) that can be performed using the application.

FIG. 5 is another example of an output from the application, illustrating the website inside an iframe with bold black lines for geographic areas.

FIG. 6 is another example of an output from the application, where the dataset has been filtered to reduce the number of parcels, and each geographic area (hexagon) is shaded to reflect the number of coordinate points or other attributes.

### DETAILED DESCRIPTION

In the following detailed portion of the present description, the teachings of the present application will be explained in more detail with reference to the example embodiments shown in the drawings.

### INTRODUCTION

One implementation of the invention is for a browser-based geospatial visualization tool. As an example, this tool allows employees of a company to navigate to a website and see a map with the locations of the company's assets represented by points on the map. In contrast to existing inventions, this system does not require a server to process the data before it is consumed by the application. Rather, when the web page is loaded by the user, a raw, unaggregated data file and application bundle is transferred to the user's browser from a remote host that supports serving static data files.

Data processing, including filtering, aggregation, and conversion necessary to show the user a desired view, is performed by an embedded database that is included in the application bundle. As the user interacts with the user interface (e.g., selecting a data type to display), the system determines a query to fetch the required data. This query is then executed locally by the embedded database, resulting in a result set. This result set can then be transferred directly to the GPU (graphics processing unit) for visualization to the user on a display. As the result set does not need to be transferred over a network, complexities and computational overhead related to networking, data serialization and deserialization, and encryption and decryption can be eliminated.

### Process Overview

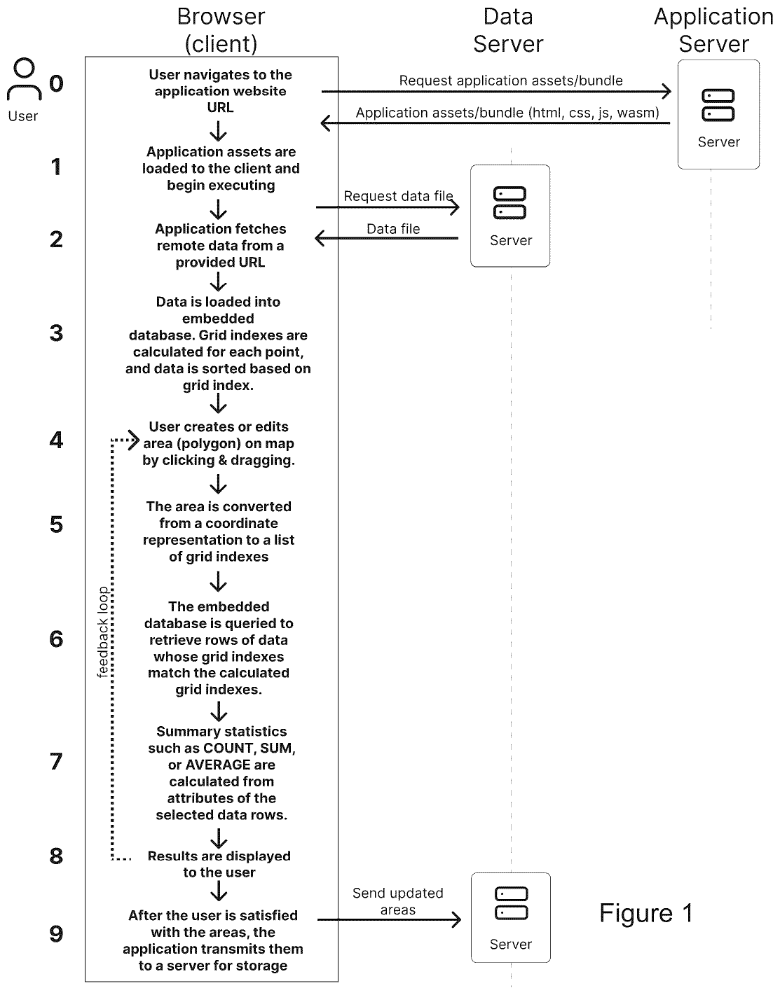

FIG. 1 is a diagram illustrating one example of a process implemented to use the client-side tool. In this example, the tool (application) executes within a browser of a computer, although in other examples the tool may execute in other client environments, such as within a standalone application. To load the tool, a user navigates to a website hosting the application (step 0). This includes the user's browser requesting the application assets or bundle from a server identified by a URL. This request can be sent over the Internet. The server provides the application assets or bundle (which include the embedded database) in response to the request back over the Internet from the Application server to the client device (e.g., personal computer, mobile device). The application assets are then loaded and executed by the browser in the client device (step 1).

Once the application is executing on the client device, the application fetches one or more data files containing the data (e.g., geographic data) the user desires to analyze (step 2). In an example, the user can direct the application to the particular data file(s) they would like to analyze. In the example shown in FIG. 1, the data file is on a server, for example, a server that holds data of the user or an entity that the user works for or with (e.g., a company server). This server can be located nearby the client device (e.g., on the same LAN) or can be accessed over the Internet. In any case, the data file is received by the client device and loaded into the application.

The data file(s) includes geographic data to be analyzed by the tool. This geographic data can include coordinate points (e.g., latitude and longitude coordinates) corresponding to an interest of the user. For example, the coordinate points can be the location of customers of a business the user is associated with. The data file can also include other geographic points, lines, or polygons having associated attributes. Examples could include a polygon corresponding to a particular zip code, a polygon defining an average income of an area, a polygon defining a census district, wherein the zip code, average income, and census district are the respective attributes for each of the polygons. Other geographic points, lines, or polygons having associated attributes could be used. Since the attributes have a corresponding geographic region, the attributes can be associated with one or more coordinate points that fall within that geographic region. The data file(s) can also include attributes directly associated with the coordinate points. The data file(s) can also include view configuration information that customizes the view of the interface presented to the user by the application. For example, the particular features or colors presented by the tool can be indicated in the configuration information.

The application executing on the client device then loads the data from the data file into a database embedded in the application (step 3). This can be an integer-based indexed OLAP database. The application executing on the client device calculates grid indexes for each coordinate point using a Discrete Global Grid System (DGGS) such as H3, produced by Uber Technologies Inc. This process associates each coordinate point with a single integer value (grid index), wherein each integer value corresponds to a distinct geographic area (e.g., hexagon region) on the Earth. Hexagon regions that are geographically nearby one another can have integer values that are near one another. For example, geographic area number #12 can be geographically nearby geographic area #14, but geographically farther from geographic are #54. A particular geographic area can have one or more than one coordinate point associated therewith. In an example, each geographic area is about the same geographic size. Once indexed, the data can be sorted in the database by the integer value in ascending or descending order so that coordinate points that are geographically near one another are saved in the database nearby one another. Other methods of generating indexes, such as R-Trees, may also be utilized.

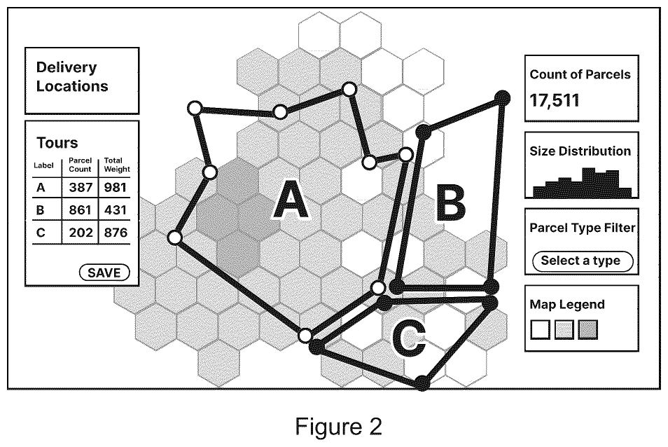

The geographic areas are displayed for the user by the application. One example of a user interaction is the user can then create and edit a point, line, or polygon to capture a geographic area (step 4). FIG. 2 depicts an example of an output from the application, showing an irregular polygon that the user has drawn to capture a geographic area of interest. The vertices of the point, line, or polygon can be created by clicking and dragging in the application interface. After completing the polygon, point, or line, the application computes a list of grid indexes that fall within the polygon (step 5). This can be accomplished with the polyfill function. For points and lines, the application computes a list of grid indexes that fall within a buffer zone around the point or the line. Once the list of indexes that fall within the point, line, or polygon is identified, the coordinate points that correspond to each index in the list of indexes is retrieved (step 6) from the database. The application then displays the results of the query by displaying the number of coordinate points within the point, line, or polygon, and/or any attribute associated with those coordinate points (step 7). In the example shown in FIG. 2, the coordinate points correspond to parcel delivery locations with an attribute of the weight of each parcel. The polygon in FIG. 2 represents a delivery tour and the application displays the number of parcels to be delivered in that area and the total weight of the parcels in that area. The application also allows filtering of the coordinate points, such that a subset of coordinate points can be analyzed, for example, only parcels having a weight below a certain threshold are analyzed. The application identifies all data points or cells overlapping the polygon and updates the display immediately.

### Data Update Cycle

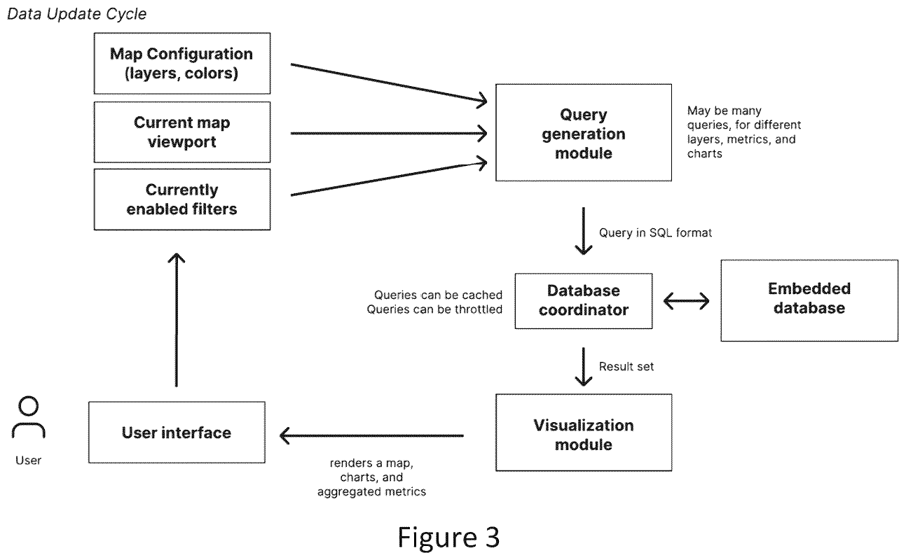

FIG. 3 details the data update cycle. The cycle consists of the following modules:

Query generation module: Builds an SQL-like statement based on the map configuration, current viewport, and active filters. For example, if the user is zoomed into New York City, the query will include a filter limiting the returned data to this area. If the points on a map are colored by ‘Attribute B’, then the query will select this attribute from the dataset and may calculate the appropriate colors to display.

Database coordinator: Manages load on the embedded database, caches query results, and throttle requests if too many are received in rapid succession.

Embedded database: Executes incoming queries given to it in SQL format against tables that were loaded when the application started running. Data is loaded into the database by the user or when a previously saved map is loaded. During a data update cycle, the database receives a SQL query, executes it, and returns a result set.

Visualization module (map): Renders points, lines, polygons, arcs, or H3 cells onto the map. The appearance of the rendered data may differ for different types of data, and is defined in the map configuration. For example, if the map configuration defines a layer of points, the visualization module will take a result set that has latitude and longitude data and render it to the map. To make rendering faster, the visualization module is designed to accept result set data with a memory layout which can be loaded to the GPU and rendered without large amounts of intermediate data processing.

Visualization module (charts & metrics): Displays aggregated numbers (‘metrics’) or charts (bar charts, histograms, etc.) derived from the same result sets. As this module handles aggregated data, the volumes are much lower and optimization is not as important.

The user interface consists of a map with a series layers on top of it. The map layers allow users to render data onto the map itself, with a variety of layer objects. There are also other elements to the user interface, which sit on top of the map. These ‘components’ may include a title, map legend, filters, charts, and metrics. Just as map layers rely on the output of an update cycle, these components update in real-time as the state of the map configuration, current viewport, and current filters change. In addition, some components such as the filter component change the state of the map, leading to re-computation and rendering of related map layers and other charts.

### Examples of User Interaction

Another example of a user interaction is zooming in and out on the map by clicking a button on the screen or using the scroll wheel. This interaction causes the viewport to change. The Query generation module then builds a new query which selects only data which intersects with the new viewport. This query is then executed by the embedded database. The database executes the query, using the indexes and the optimized data layout to speed up execution. The output result set is then sent to the visualization module, which renders it to the screen to be viewed by the user. All of these steps can be performed quickly (e.g. in less than 80 ms) such that the user receives immediate feedback and does not need to wait to see new data after they zoom in/out on the map.

Another example of a user interaction is applying a filter to the dataset. The application supports a variety of filters, which are presented as user interface elements. As an example, a map showing the locations of many restaurants may have a filter for an attribute such as ‘restaurant type’, with values such as ‘pizza’, ‘sandwiches’, and ‘breakfast’. When the user selects one or multiple restaurant types to filter for, this triggers an update cycle. This update cycle is similar to what is described above—the query generation module builds a new query, executes it on the embedded database, and returns the result set to the visualization module.

Because the application executes on a client-side and has processes the coordinate points by associated index, steps 5-8 can be performed quickly (e.g., in less than 80 ms) such that the user receives immediate feedback upon inputting a point, line or polygon into the application. For example, the results can be updated immediately upon a user “dropping” (e.g., moving) a vertex or point. This enables the user to adjust the point, line, or polygon and/or input new or additional points, lines, or polygons quickly, in a trial and error manner and receive immediate feedback on each new input. Multiple points, lines or polygons can be input and computed for a single data set and map.

### Throttling Queries and Caching Results

A user action may trigger more than one update cycle. Different map elements, such as map layers or charts displayed on top of the map, each require different data aggregation. If a user action is related to the data that the map layer or chart displays, then an update cycle is triggered. This may result in a large number of update cycles being triggered continuously as a user interacts with the map. To handle such cases, the application can also throttle or cache the user's input or queries to the database (using the ‘database coordinator module’), enhancing the efficiency and responsiveness of the application during high-frequency user interactions. This feature can maintain optimal performance and avoid database overload, particularly when a user is creating and editing a point, line, or polygon, which could generate rapid coordinate changes (more than 30 times per second). By implementing a query throttling mechanism, the application determines the frequency at which queries are dispatched to the database. It effectively drops excessive requests, ensuring that the user perceives a seamless real-time update experience. Additionally, when identical queries are repeated, the application can swiftly deliver cached responses, avoiding redundant database computations.

### Saving and Retrieving Map Metadata

A user may want to save the current state of a map so it can be reloaded at a later time or shared with other users. The user can provide input to the application instructing the application to save the particular map layers, charts, aggregations, and viewport to a data file. This data file can be stored on a server to be loaded by an instantiation of the application at a later time to see or update the map. This data file contains ‘metadata’ about the map, including data layers to display, components within the UI, and data aggregation logic. This data layer includes a list of data sources, however it does not include the raw data itself. It includes ‘pointers’ or URLs to the external location or system where the data is stored. It may also include a series of instructions for accessing the data, such as the text of a query to run against a remote system to fetch data.

When another user wants to view a previously saved file, they can specify the location of this file to the application. The application will then load the previously saved metadata file. The previously saved map may also be saved into a shareable URL object, or the user may select the saved map through a user interface.

After loading the saved map metadata, the application will then use the locations of the data sources defined in the metadata to load the raw, unaggregated data. The application will then initiate a series of update cycles, generating queries based on the saved application state, executing the queries in the embedded database, and rendering the returned result sets onto the map. It will repeat this process for all data sources, map layers, and components until the map state is identical to the state of the original map when it was saved.

The ability to save the view of a map (‘metadata’), without saving the underlying map data itself, allows the map to easily display updated data. For example, a business user for a car rental company could build a map that shows the location of their vehicles. When other users load this map, they see the same map layers and metrics that the initial user defined, however, the data used to generate these metrics has been updated with real-time data. This design allows maps to be built once but display different data.

Maps may be shared in ‘read-only’ mode. In this case, the application will load data and components for the user as usual, however the user will not be able to edit the map layers or change the components. They will be able to zoom in and out on the map and apply filters, however. This is useful for users who need to consume the data from the map but do not have the knowledge to create the map themselves.

Exporting Data from the Application

Once a user finalizes the output of a particular input of point(s), line(s), or polygon(s), the user can provide input to the application instructing the application to save the particular points, lines, or polygons input, along with the calculated grid indexes for each coordinate point in a new data file (step 9). This data file can be stored on a server to be loaded by an instantiation of the application at a later time to see or update the results. The data file can also be exported for offline or external processing. This is particularly valuable for workflows where smaller subsets of data must be transferred to other tools.

The application also allows the user to extract data to a static file by filtering a specific area on the map by drawing a polygon object and then downloading the raw data that exists within this area.

### Linear Programming/Optimization Process

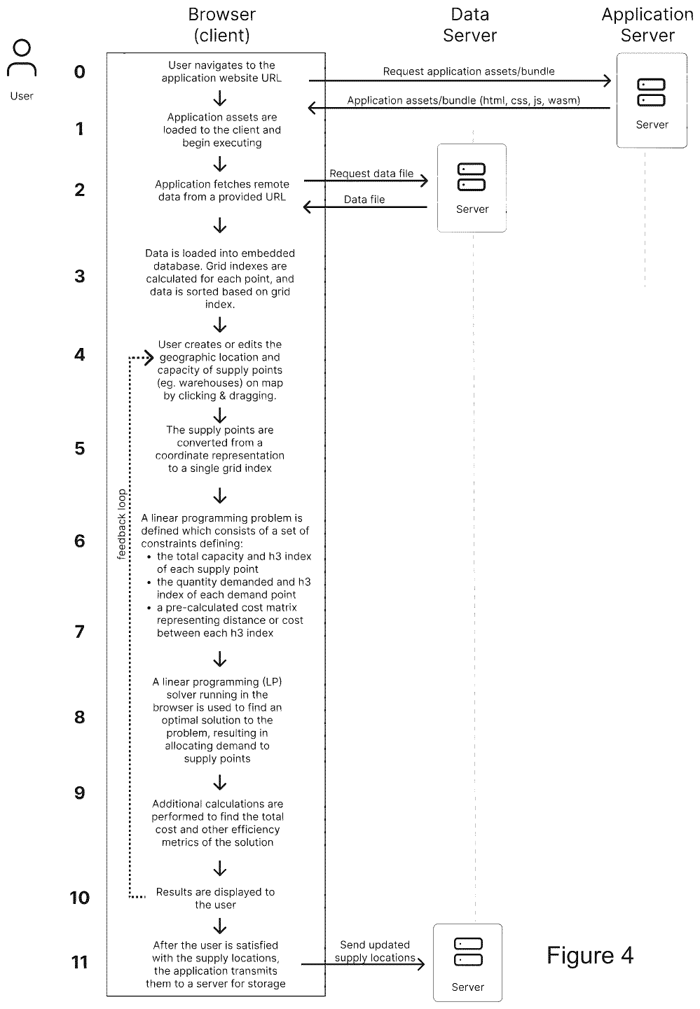

FIG. 4 is a diagram illustrating another process that can be performed using the application. In FIG. 4, steps 1-3 are the same as described above with respect to FIG. 1. Once the data is loaded into the application, the user can create or edit one or more locations and attribute (e.g., capacity) for each location (e.g., a warehouse and its delivery capacity) by clicking various locations on the map displayed by the application (step 4). The application can then identify a single grid index corresponding to each location. The application then performs a linear programming algorithm with inputs of the attribute and grid index for each location, a value corresponding to the attribute and its associate grid index (e.g., the number of deliveries for each respective grid index) and a cost associated with each grid index (e.g., a value that assigns a higher cost to further delivery trips) (steps 6-7). The linear programming algorithm then finds a solution which allocates each grid index to an input location (e.g., warehouse) if possible (step 7). Additional calculations can also be performed (step 9). For example, the cost of delivery from a particular warehouse or the total cost of delivery from multiple warehouses can be computed. This result can be displayed graphically to the user (step 10). Similar to FIG. 1, steps 5-9 can be performed quickly (e.g., in less than 80 ms) such that the user receives immediate feedback upon inputting a location into the application. The user's input of a location into the application can also be throttled or cached to enhance the efficiency and responsiveness.

Once a user is satisfied with the output of a particular input of locations and attribute, the user can provide input to the application instructing the application to save the particular locations and attributes, along with the calculated grid indexes for each in a new data file (step 11). This data file can be stored on a server to be loaded by an instantiation of the application at a later time to see or update the results.

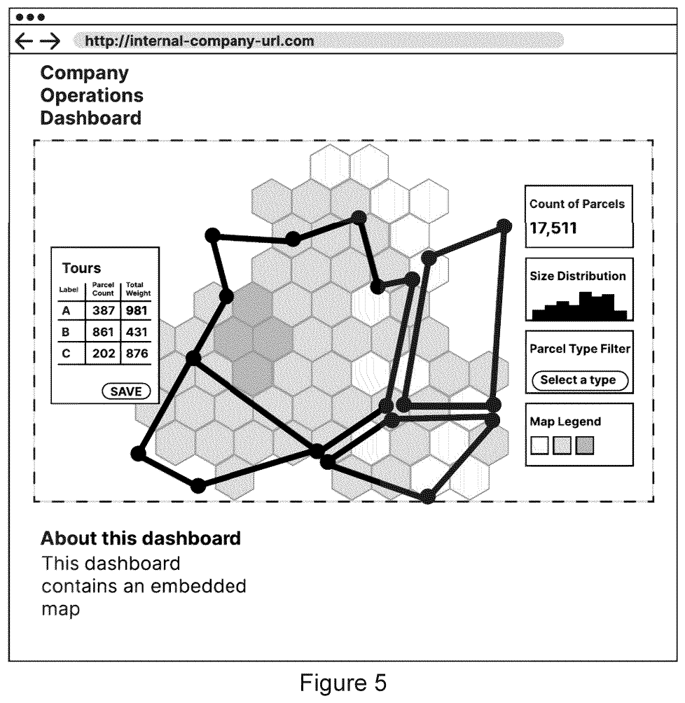

FIG. 5 shows another example of an output, illustrating a web-based interface with bold black polygons designating user-defined boundaries or zones. These polygons can be used for grouping, filtering, or analyzing associated points.

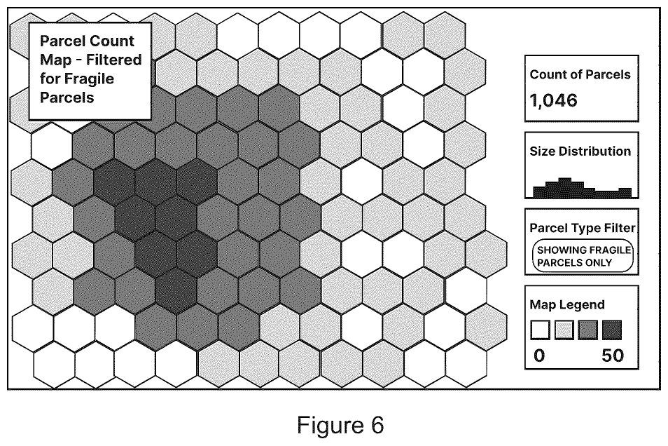

FIG. 6 is another example of an output, illustrating how individual geographic cells (e.g., hexagon) might be shaded according to the number of coordinate points in each cell or aggregated attributes (e.g., number of parcels, population counts). This allows the user to see spatial patterns at a glance.

What is claimed is:

1. A non-transitory computer readable medium comprising:
an application bundle for implementing a geographic information system (GIS), the application bundle including an embedded database and configured to:
be sent over the internet to a client device in response to navigation in a browser on the client device to a URL for the bundle; and
execute within the browser on the client device, wherein the application bundle, when executed within the browser, causes the client device to:
load data corresponding to a geographic area from a data server into the embedded database, the geographic data including:
a plurality of coordinate points corresponding to a plurality of locations of interest in the geographic area; and
one or more attributes for each coordinate point;
space partitioning the geographic area into a plurality of cells and assigning, as a grid index for each cell, a unique identifier for each cell;
associate each coordinate point with a single grid index corresponding to a cell that the coordinate point is within;
receive input from a user of the client device, the input indicative of a first region to analyze in the geographic area;
identify, as a first set of grid indexes, which grid indexes of the plurality of grid indexes are within the first region;
calculate desired statistics from the attributes of the coordinate points associated with each grid index in the first set of grid indexes; and
display the desired statistics on the client device.

2. The non-transitory computer readable medium of claim 1, wherein the application bundle, when executed within the browser, causes the client device to:
receive a second input from a user of the client device, the second input indicative of a second region to analyze in the geographic area;
identify, as a second set of grid indexes, which grid indexes of the plurality of grid indexes are within the second region; and
calculate desired statistics from the attributes of the coordinate points associated with each grid index in the second set of grid indexes.

3. The non-transitory computer readable medium of claim 2, wherein receive a second input indicative of a second region is an adjustment to the first region.

4. The non-transitory computer-readable medium of claim 1, wherein the application bundle, when executed within the browser, causes the client device to:
display a map within the browser, wherein receive input includes receive first input from a user clicking one or more points on the map to identify the first region.

5. The non-transitory computer readable medium of claim 1, wherein the application bundle, when executed within the browser, causes the client device to:
send the first set of grid indexes, an indication of each coordinate point associated with each grid index in the first set of grid indexes, and the coordinate points to a server for storage in response to user input corresponding thereto.

6. The non-transitory computer readable medium of claim 1, wherein the application bundle, when executed within the browser, causes the client device to:
receive a third input from a user indicative of the desired statistics to calculate.

7. A non-transitory computer readable medium comprising:
an application bundle for implementing a geographic information system (GIS), the application bundle including an embedded database and configured to:
be sent over the internet to a client device in response to navigation in a browser on the client device to a URL for the bundle; and
execute within the browser on the client device, wherein the application bundle, when executed within the browser, causes the client device to:
load data corresponding to a geographic area from a data server into the embedded database, the geographic data including:
a plurality of coordinate points corresponding to a plurality of locations to which one or more packages are to be delivered; and
one or more attributes for each coordinate point, the one or more attributes corresponding to characteristics of the one or more packages for the plurality of coordinate points;
space partitioning the geographic area into a plurality of cells and assigning, as a grid index for each cell, a unique identifier for each cell;
associate each coordinate point with a single grid index corresponding to a cell that the coordinate point is within;
providing a location and a capacity of a plurality of supply points;
associate each supply point of the plurality of supply points with a single grid index corresponding to a cell that the supply point is within;
solve a linear programming problem to allocate each coordinate point of the plurality of coordinate points to a single supply point of the plurality of supply points based on a cost matrix representing a cost to deliver a package between each of the plurality of grid indexes; and
display a representation of the allocation of each coordinate point to a single supply point on the client device.

8. The non-transitory computer readable medium of claim 7, wherein the application bundle, when executed within the browser, causes the client device to:
receive input from a user regarding at least one of the location or capacity of one or more of the plurality of supply points.

9. The non-transitory computer readable medium of claim 8, wherein the application bundle, when executed within the browser, causes the client device to:
update an association of each supply point of the plurality of supply points with a single grid index corresponding to a cell that the supply point is within;
re-solve a linear programming problem to allocate each coordinate point of the plurality of coordinate points to a single supply point of the plurality of supply points based on a cost matrix representing a cost to deliver a package between each of the plurality of grid indexes; and
display an updated representation of the allocation of each coordinate point to a single supply point on the client device.

10. The non-transitory computer-readable medium of claim 8, wherein the application bundle, when executed within the browser, causes the client device to:
display a map within the browser, wherein receive input includes receive input from a user clicking one or more points on the map to identify one or more locations of one or more supply points.

11. The non-transitory computer readable medium of claim 7, wherein the application bundle, when executed within the browser, causes the client device to:
calculate a total cost of delivering to the plurality of coordinate points based on the allocation of each coordinate point to a single supply point on the client device; and
display the total cost on the client device.

12. The non-transitory computer readable medium of claim 7, wherein the application bundle, when executed within the browser, causes the client device to:
send the supply locations and capacities to a server for storage in response to user input corresponding thereto.

13. The non-transitory computer-readable medium of claim 1, wherein the application bundle, when executed within the browser, causes the client device to:
display a map within the browser, wherein receive input includes receive first input from a user adjusting the map by zooming and panning to define the first region.

14. The non-transitory computer-readable medium of claim 8, wherein the application bundle, when executed within the browser, causes the client device to:
display a map within the browser, wherein receive input includes receive input from a user zooming and panning one or more points on the map to identify one or more locations of one or more supply points.

15. A computer-implemented method for geographic data analysis, the method comprising:
sending an application bundle over the internet to a client device in response to navigation in a browser on the client device to a URL for the bundle;
executing the application bundle within the browser on the client device;
loading geographic data corresponding to a geographic area from a data server into an embedded database within the application bundle, wherein the geographic data includes:
a plurality of coordinate points corresponding to a plurality of locations of interest in the geographic area; and
one or more attributes for each coordinate point;
space partitioning the geographic area into a plurality of cells and assigning, as a grid index for each cell, a unique identifier for each cell;
associating each coordinate point with a single grid index corresponding to a cell that the coordinate point is within;
receiving input from a user of the client device, the input indicative of a first region to analyze in the geographic area;
identifying, as a first set of grid indexes, which grid indexes of the plurality of grid indexes are within the first region;
calculating desired statistics from the attributes of the coordinate points associated with each grid index in the first set of grid indexes; and
displaying the desired statistics on the client device.

16. The method of claim 15, further comprising:
receiving a second input from a user of the client device, the second input indicative of a second region to analyze in the geographic area;
identifying, as a second set of grid indexes, which grid indexes of the plurality of grid indexes are within the second region; and
calculating desired statistics from the attributes of the coordinate points associated with each grid index in the second set of grid indexes.

17. The method of claim 16, wherein receiving the second input indicative of a second region comprises receiving an adjustment to the first region.

18. The method of claim 15, wherein displaying the map within the browser comprises receiving first input from a user clicking one or more points on the map to identify the first region.

19. The non-transitory computer readable medium of claim 1, wherein receive input indicative of a first region includes receive a selection of a region already defined in the data.

20. The non-transitory computer readable medium of claim 1, wherein receive input indicative of a first region includes receive input from a user defining a custom region.
